(19) United States
(12) Patent Application Publication
(10) Pub. No.: US 2025/0242401 A1
(43) Pub. Date: Jul. 31, 2025

(54) METHOD AND APPARATUS FOR EXPANDING TUBE BLANKS

(71) Applicant: Hoffmann Neopac AG, Thun (CH)

(72) Inventors: Michael Wagner, Oberdiessbach (CH); Kristijan Eberhard, Etziken (CH)

(73) Assignee: Hoffmann Neopac AG, Thun (CH)

(21) Appl. No.: 18/729,466

(22) PCT Filed: Aug. 16, 2023
(86) PCT No.: PCT/EP2023/072585

§ 371 Date: Jul. 16, 2024

(30) Foreign Application Priority Data
Apr. 18, 2023 (CH) CH000397/2023

(51) Int. Cl. B21D 9/04

(52) U.S. Cl. CPC B21D 9/04

(57) ABSTRACT

SUMMARY

The invention relates to a method and a device for expanding at least a section of an initial tube blank (2) made of plastic or metal in such a way that an expanded tube blank (1) is obtained which tapers in the direction of an end of the tube blank that is not affected by the expansion process. The initial tube blank is fixed in a holding device (4) in a first position (6a), a first mandrel (3) is inserted into the initial tube blank, pressed therein and held in the pressed-in position for a predetermined heating time period, so that at least a part of the tube blank is expanded, and finally the first mandrel is pulled out of the expanded tube blank (1), wherein, when the first mandrel is pulled out of the tube blank, either compressed air is blown into the interior of the expanded tube blank through the first mandrel provided with at least one corresponding first air channel (5), or the expanded tube blank is mechanically stripped off.

### REFERENCE TO RELATED APPLICATIONS

This application claims priority to Swiss patent application CH000397/2023, filed Apr. 18, 2023, the entire disclosure of which is hereby incorporated by reference.

### FIELD OF INVENTION

The invention relates to a method and an appa-ratus for expanding initial tube blanks of plastic or of metal according to the respective independent claim.

### BACKGROUND

It is known to expand initially cylindrical tube blanks so that they acquire a conical shape. Such processes have been developed to save space during storage and transport of tube blanks, since unlike the cylindrical shape, a conical shape allows the blanks to be nested into one another. The existing processes involve a large number of steps until a conical tube blank is achieved. Many of these steps do not serve to actually expand the cylindrical blank, but on the one hand to ensure that the blank does not crack during expansion, and on the other hand to remove the conical blank from the expansion device.

For example, EP0098669 discloses a method and a device in which, in a phase B, the tube is slipped onto a preheated mandrel. In phase C, an upper tool is placed on the mandrel and driven onto the mandrel as far as it will go, expanding the tube by means of cold forming. After removal of the upper tool, the tube still on the mandrel is heated again in a phase D and finally cooled on the mandrel in a phase E before the conical tube can be removed.

### DESCRIPTION OF THE INVENTION

The objective to be reached is to simplify the production of conical tube blanks starting from cylindrical tube blanks.

This objective is reached in accordance with a first aspect of the invention by means of a method for expanding at least a part of an initial tube blank made of plastic or metal in such a way that an expanded tube blank is obtained, which tapers in the direction of an end of the tube blank which is not affected by the expansion process. In a first step a) of the method, the initial tube blank is fixed in a holding device in a first position, after which, in a second step b), a first mandrel preheated to a first target temperature is inserted into the initial tube blank. A longitudinal axis of the first mandrel coincides with a longitudinal axis of the initial tube blank. A maximum diameter of the first mandrel is larger than a maximum diameter of the initial tube blank, so that the tube blank can be expanded. In a third step c), the first mandrel is pressed into the interior of the initial tube blank to a predetermined depth and held in the pressed-in position for a predetermined heating period, so that at least part of the tube blank is expanded. Finally, in a fourth step d), the first mandrel is pulled out of the expanded tube blank, wherein, when the first mandrel is pulled out of the expanded tube blank, either compressed air is blown into the interior of the conical tube blank through the first mandrel provided with at least one corresponding first air channel, or the expanded tube blank is mechanically stripped.

The objective is further reached according to a second aspect of the invention by means of a device for expanding at least a part of an initial tube blank made of plastic or metal in such a way that an expanded tube blank is obtained which tapers in the direction of an end of the tube blank not affected by the expanding process, using the method according to the first aspect of the invention. The device comprises a holding device for fixing the initial tube blank in the first position, a first mandrel having a maximum diameter larger than the maximum diameter of the initial tube blank, a heater for preheating the first mandrel to the first target temperature, and a first linear actuator for linearly shifting the first mandrel back and forth from an initial position in which the first mandrel is disposed completely outside the initial tube blank fixed in the first position and the pressed-in position.

The present invention has the advantage that only one element, the first mandrel, is responsible for the expansion and no interaction with another element is necessary, as for example in the above-mentioned method of the prior art, in which an upper tool has to cooperate with a mandrel. Here, the initial tube blank to be expanded can be held in a simple holding device at one end while being acted upon solely by an up-and-down movable mandrel. Furthermore, a step of reheating the tube blank by means of an infrared radiator can also be saved.

### BRIEF DESCRIPTION OF THE DRAWINGS

Further embodiments, advantages and applications of the invention result from the dependent claims and from the description now following on the basis of the figures. Thereby it is shown in:

FIG. 1 a sectional view of a cylindrical tube blank that has not yet been machined,

FIG. 2 a sectional view of the tube blank of FIG. 1 during the expansion process according to the invention with a first mandrel pressed into it,

FIG. 3 a sectional view of the finished conical tube blank,

FIG. 4 a top view of an expanded tube blank with an oval cross-section,

FIG. 5 a top view of an expanded tube blank with a circular cross-section,

FIG. 6 a top view of an expanded tube blank with a star-shaped cross-section, and

FIG. 7 an embodiment of a device according to the invention for producing the conical tube blank of FIG. 3 or 5, respectively.

### WAYS TO CARRY OUT THE INVENTION

Here, the term “tube blank” includes containers made of plastic in the manner of tubes for toothpaste, lotions, etc. or made of metal in the manner of tubes for oil paints, water colors, etc.

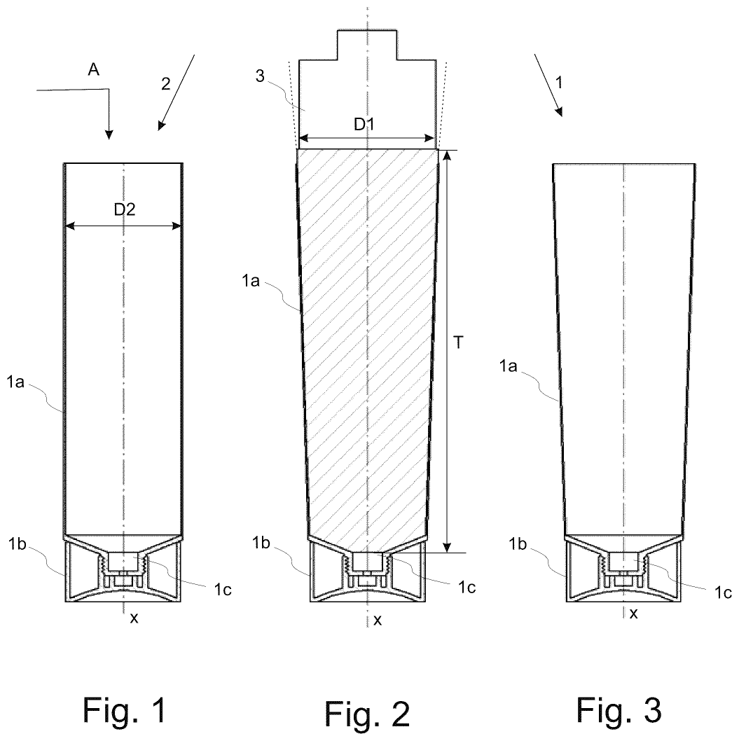

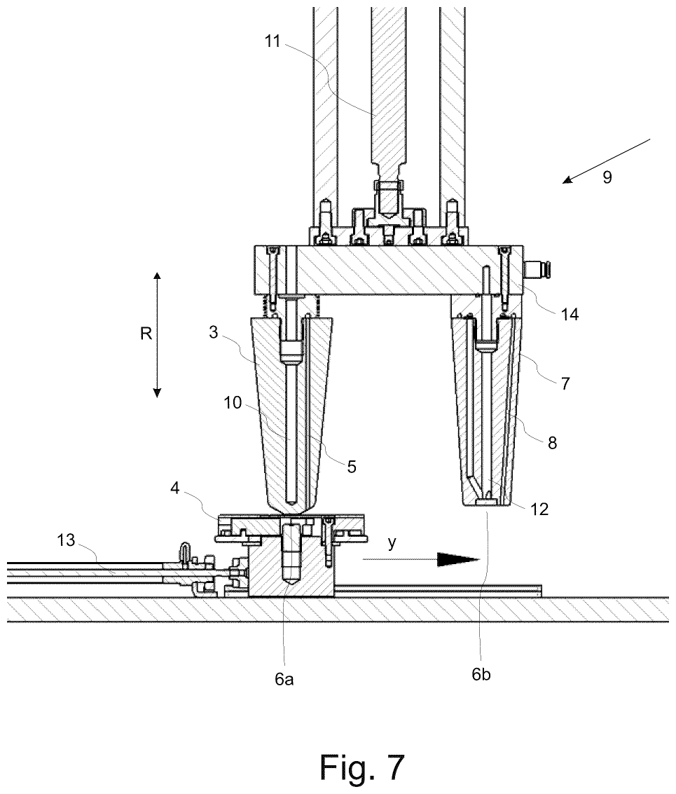

Such a tube blank may be open on both sides prior to processing by means of the present invention, that is, it may be a simple tube, or it may be closed at one end. For example, with reference to FIG. 1, the cylindrical tube blank 2 may have a cylindrical tube body 1a and at one end a tube head 1b which is responsible for the subse-quent dispensing of tube contents from the opening 1c and for closing the tube. In the present case, it is preferred if the tube head is already attached to the tube body or has been manufactured in one piece with the tube body, since the tube head can be used for the expanding processing of the tube body in a simple manner due to its comparatively rigid structure as a means for holding the tube blank in a holding device 4 (FIG. 7). Furthermore, the rigid structure also gives the tube body more structural support.

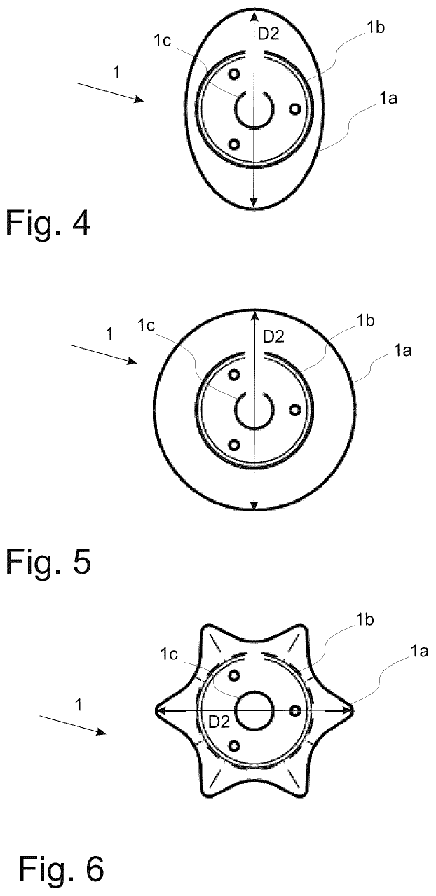

The invention is explained in detail below on the basis of a cylindrical tube blank. Other types of tube blanks are described in the context of FIGS. 4-6. The cylindrical tube blank is exemplarily made here from a themoplastic, for example, by extrusion or as a longitudinally welded plastic tube or as an injection-molded plastic tube. This is known and will not be described in detail herein. Tube blanks made of metal may be produced according to other processes known for this application. In this connection, it is noted that the invention described below for the application to plastic blanks applies mutatis mutandis to metal blanks, although some parameters may have to be changed, e.g. temperature values for heating the blank. The basic steps of the expanding process according to the invention and the structural design of the manufacturing device according to the invention remain the same.

FIGS. 1 to 3 show the sequence of a tube blank from the initial state shown in FIG. 1 to the final state of the machined, now conical tube blank. Where the term “tube blank” or “blank” or similar is used in the following, this refers to properties for which the state is irrelevant or to a transitional state between the initial state and the final state. In the initial state of the untreated cylindrical tube blank, it has a constant diameter D2. In FIG. 2, the state during the expansion process is shown in which a first mandrel 3 for expanding the tube blank is inserted into the tube blank up to a depth T in a pressed-in position and expands it conically, resulting in a maximum diameter D1 of the conical tube blank that is larger than the initial diameter D2. Thus, the first mandrel 3 has a minimum diameter smaller than a diameter D2 of the cylindrical tube blank, so that it can be inserted into the latter, and a maximum diameter larger than the diameter of the cylindrical tube blank, so that the latter can be expanded. However, this maximum diameter of the first mandrel does not necessarily correspond to the diameter D1; it can be even larger than this diameter. The reason for this is that due to the conical design of the first mandrel, it can be used for different tube sizes and does not have to be exchanged. This is indicated in FIG. 2 with the dashed lines. Thus, a larger expansion for a larger tube blank would also be possible here. FIG. 3 shows the finished conically expanded tube blank.

FIGS. 4 to 6 show examples of various possible cross-sections of the tube blank in top view in the direction of arrow A from FIG. 1, although the invention is not limited to these cross-sectional shapes. The figures show tube blanks 1 which have already been machined, i.e. expanded, and which taper as seen in the drawing plane. FIG. 4 shows an expanded tube blank with an oval cross-section, FIG. 5 an expanded tube blank with a round cross-section and FIG. 6 an expanded tube blank with a star-shaped cross-section. It is visible that the tube blank 1b is preferably always round. In the preferred case of a tube blank with an already existing tube head, the shape of the tube body 1a is such that, viewed from the free end of the tube body where the expansion process begins, in the direction of the tube head, the tube body in the initial state has an essentially constant course with respect to shape and maximum diameter, at least in certain sections. In other words, the outer surface of the tube body is parallel to the longitudinal axis x of the tube body at least in certain sections. This means that the cross-section of the tube body is constant in this area. The cross-section of the tube body can only change in a section directly in the vicinity of the tube head, but this is irrelevant for the expansion process.

This is not the case for a tube body with a circular cross-section (FIG. 5), since the diameter of the tube body corresponds to the diameter of the tube head and the circular cross-section of the tube body corresponds to the circular cross-section of the tube head.

In the case of a tube body with an oval cross-section (FIG. 4) or star-shaped cross-section (FIG. 6), the oval or star-shaped cross-section of the tube body changes to a circular cross-section in the area immediately adjacent to the tube head in such a way that the tube head is flush with the tube body. The initial tube blanks can have any cross-sectional shape, either having a continuous contour, exemplified here by the oval contour, or having a contour provided with corners, exemplified here by the star-shaped contour. In this context, it is also noted that the diameter D2 is always the maximum diameter present for the cross-sectional shape in question, in the manner in which the diameters in FIGS. 4-6 are intentionally drawn in the position shown. Although the tube bodies with other cross-sectional shapes than the circular cross-sectional shape are also to be considered as cylindrical to a certain extent due to their elongated extension, for the sake of simplicity, “cylindrical tube blanks” will be referred to herein in connection with the example of the circular cross-sectional shape considered here. The same applies to the term “conical”, which is generally to be interpreted as “tapering” irrespective of the cross-section.

Naturally, a corresponding first and, if necessary, second mandrel is provided for each cross-sectional shape of the tube blank. In the case of an oval cross-sectional shape of the initial cylindrical tube blank, the mandrels are correspondingly conically oval and taper in the direction of insertion into the tube blank, with the expansion beginning at a certain insertion depth when the diameter of the first mandrel exceeds the maximum diameter of the tube blank and continues to increase steadily. In the case of a circular cross-section of the tube blank, the first mandrel or the second mandrel has the shape of a cone. In the star-shaped cross-section of the tube blank, the mandrels are also star-shaped in cross-section and taper in the manner described above for the oval cross-section. It is noted that throughout this document the cross-sectional shape at the free end of the initial tube blank, where it is expanded, is assumed to be representative. Any changes in cross-sectional shape at the transition to the tube head are neglected.

The first and second mandrels are preferably made of a suitable metal, such as steel. However, they can also be made of another material that is stable with respect to shape at the required temperatures.

FIG. 7 shows a simplified embodiment of a device 9 according to the invention for producing the conical tube blank of FIG. 3. For simplification, no tube blank is shown here.

The device 9 comprises a holding device 4 for fixing the cylindrical tube blank 2 in a first position 6a. The first position, as well as a second position 6b explained later, refer to a preferably horizontal transport direction y (see arrow) of a tube blank. The holding device can be of one piece and have a recess in which the tube head of the cylindrical tube blank can be inserted, or it can comprise several jaws which enclose the tube head 1b after it has been positioned, which is preferred for tube blanks varying in size.

The device 9 further comprises the aforemen-tioned conical first mandrel 3. As already described, the tube blanks to be processed can have different cross-sectional shapes. Accordingly, several first mandrels with different cross-sectional shapes are provided in the device for expanding tube blanks. In particular, these can have a circular or oval or star-shaped cross-sectional shape, which are each assigned to initial tube blanks with correspondingly identical cross-sectional shapes (see FIG. 4-6). When a first initial tube blank is exchanged with a second initial tube blank having a different cross-section, the first mandrel used for the first tube blank is correspondingly exchanged with a second mandrel for the second tube blank in the device. For the exemplary embodiment of the initial tube blank described here as being cylindrical with a circular cross-section, mandrels are thus used which also have a circular cross-section and taper conically. In the following, conical mandrels will be referred to as representative of all types of usable mandrels.

In order to prevent the cylindrical tube blank from cracking during expansion, it is heated. For this purpose, the first mandrel 3 is provided with a heater 10 which heats the first mandrel to a first target temperature before the first mandrel is inserted into the tube blank 2. The first target temperature can vary for different types of the thermoplastic material and is selected so that the cylindrical tube blank undergoes cold forming so that it retains its original shape after processing and subse-quent cooling.

It is preferred if the heater 10 comprises a first temperature sensor and a first controller (not shown) to control the actual temperature of the first mandrel. The first controller sets the first target temperature of the first mandrel based on an actual temperature of the first mandrel measured by the first temperature sensor. It is preferred if after expanding each cylindrical tube blank or a number of cylindrical tube blanks, the first target temperature of the first mandrel is checked and adjusted. The adjustment is made as a function of a temperature drop of the first mandrel due to a heat input from the first mandrel into the tube blank. Depending on the temperature drop, the first mandrel is heated up again to the first target temperature before a next cylindrical tube blank is processed with the first mandrel. However, it may also be the case that, due to material-related temperature toler-ances, the first target temperature of the first mandrel only needs to be set after a number of conical tube blanks 1 have been processed. The heater is preferably designed in such a way that, within the limits of experience for possible temperature fluctuations in the device, it can manage the heating of the first mandrel to the first target temperature within a fixed cadence time until the posi-tioning of the next tube blank 2, so that no delays occur in this respect.

The device 9 further comprises a first linear actuator 11 for linearly shifting (arrow R) the first mandrel 3 back and forth between an initial position, in which the first mandrel is arranged completely outside the cylindrical tube blank 2 fixed in the first position 6a, and the pressed-in position.

It is particularly preferred if the device 9 further comprises a conical second mandrel 7, which corresponds to the first mandrel 3 in terms of shape and volume. This second mandrel is provided for cooling the processed now conical tube blank 1, which directly increases the shape stiffness so that the conical tube blank 1 can be directly transported further for further processing with-out potentially deforming.

In connection with the second mandrel 7, the device 9 further comprises a cooling device 12 for cooling the second mandrel to a second target temperature. This may be a circuit with a cooling liquid. The above explana-tions for the first target temperature of the first mandrel apply mutatis mutandis here. In particular, the cooling device comprises a second temperature sensor and a second controller (not shown), wherein the second controller is configured such that it sets the second target temperature of the second mandrel based on a temperature of the second mandrel measured by the second temperature sensor, in particular after cooling each conical tube blank or a number of conical tube blanks.

The first and second controller can be identical and, as an overall control, provide temperature con-trols for the first and second mandrels.

Similarly to the first mandrel, the device 9 preferably comprises a second linear actuator for linear shifting (arrow R) of the second mandrel back and forth between an initial position in which the second mandrel is arranged completely outside the conical tube blank 1 and a designated position inserted into the conical tube blank for cooling the conical tube blank.

The second linear actuator can be identical to the first linear actuator 11, which is preferred if both mandrels are attached to a common frame 14 of the device 9 and operate synchronously. Synchronous operation means here that while a cylindrical tube blank 2 is being expanded, a conical tube blank 1 is being cooled at the same time so that both mandrels are lowered.

It is particularly preferred if the first mandrel 3 comprises at least one first air channel 5 for introducing compressed air into the interior of the conical tube blank 1, wherein an inlet of the first air channel is located in a region of the first mandrel that does not enter the tube blank, and the first air channel opens in the region of a free end of the first mandrel. This is analogously provided for the second mandrel 7, which comprises at least a second air channel 8 for introducing compressed air into the interior of the conical tube blank, an inlet of the second air channel being located in a region of the second mandrel that does not enter the tube blank, and the second air channel opening in the region of a free end of the second mandrel. This measure is helpful in detaching the respective tube blank from the respective mandrel. In other words, this measure prevents the tube blank from “sticking” to the mandrel due to its conical shape in interaction with a certain elasticity. Alternatively, the respective tube blank could be stripped mechanically. Alternatively, the tube blank could be held in the holding device in such a way that the holding force retains the tube blank when the mandrel is displaced up-wards. However, the first alternative is preferred as it allows a more gentle stripping of the tube blank.

In embodiments, the holding device 4 comprises a drive 13 so that the conical tube blank can be transported from the first position 6a to the above-mentioned second position 6b for cooling.

In one embodiment, the holding device 4 can be designed as an intermittently operated circulating conveyor device or intermittently operated rotating turret device with several receptacles for cylindrical tube blanks, operated by means of the drive 13. Alternatively, it can be designed as a loading table. The holding device will be further specified in the context of the following description of the manufacturing process for the expanded conical tube blanks.

In a first step a) of the method according to the invention, the cylindrical tube blank 2 is fixed in the holding device in the first position 6a. For this purpose, the holding device has corresponding receptacles which have already been described. Next, in a step b), the first mandrel preheated to the first target temperature is inserted into the cylindrical tube blank, the longitudinal axis of the first mandrel coinciding with the longitudinal axis x (FIGS. 1-3) of the cylindrical tube blank. Then, in a step c), the first mandrel is pressed into the interior of the cylindrical tube blank to the intended depth T, the tube blank expanding during this step. The first mandrel is held in the pressed-in position for a predetermined heating period. Finally, the first mandrel is pulled out of the conical tube blank 1 using the above-mentioned aids for releasing the conical tube blank.

As mentioned above, it is particularly preferred if the second mandrel is used for cooling the expanded conical tube blank.

When the second mandrel is used, the conical tube blank 1 is moved in the holding device 4 from the first position 6a to the second position 6b after the step d) of pulling the first mandrel out of the conical tube blank. For this purpose, the holding device may be configured as described above. If it is designed as an intermittently operated circulating conveyor, it comprises receptacles which circulate endlessly like the steps of an es-calator, with two receptacles being loaded with tube blanks at any given time. Alternatively, if it is designed as an intermittently operated rotating turret device, the receptacles are arranged on a horizontal plate which rotates intermittently, with two receptacles being loaded with tube blanks at any given time. In any case, the movement of the conveyor is intermittent, i.e. it occurs step by step due to the mandatory dwell time of the tube blanks in the first position 6a and possibly in the second position 6b.

Alternatively to the concept that the tube blanks are moved to the individual positions, the device 9 may be designed such that the tube blanks are stationary and the first and second mandrels are moved. In this embodiment, the holding device 4 is simple in design and may have only one receptacle for holding the tube blank. Here, the heated first mandrel 3 is exchanged with the second mandrel 7, which has been pre-cooled to the second target temperature, after step d) of pulling the first mandrel out of the conical tube blank (1). For this purpose, the linear actuator 11 already described can have an additional function which rotates the frame 14 horizontally back and forth in the initial position of the first and second mandrel, in which they are completely outside the associated tube blank, so that the first mandrel and the second mandrel are used alternately for one tube blank. This rotating function can also be performed by a separate rotary drive. In any case, for cooling the processed conical tube blank, the second mandrel, which has been precooled to the second target temperature, is inserted into the conical tube blank substantially to the intended depth T, as mentioned, the longitudinal axis of the second mandrel coinciding with the longitudinal axis x of the conical tube blank, and the conical tube blank is cooled by holding the second mandrel in the inserted position for a predetermined cooling time period. Finally, the second mandrel is with-drawn from the conical tube blank. It is noted that, in contrast to the comparable step with the first mandrel, where the term “pressing-in” is used due to the intended shaping, in this case no force shall be applied to the conical tube blank so as not to deform it. It may even be sufficient for cooling if the second mandrel does not touch the conical tube blank at all but is held at a small dis-tance from the inner walls. For this reason, the term “inserted essentially to the intended depth T” was used above.

The first alternative, in which the tube blank is shifted and the first and second mandrels are only shifted back and forth vertically (arrow R), is particularly preferred in order to simultaneously expand a next cylindrical tube blank during the cooling time span of a conical tube blank, which saves time. The most time can be saved if the heating time span and the cooling time span are selected to be the same. This can preferably be done by adjusting the first and/or the second target temperature accordingly, for example by individually changing the en-ergy input into the respective mandrel during cooling or heating.

While preferred embodiments of the invention are described in the present application, it should be clearly noted that the invention is not limited to these and may also be carried out in other ways within the scope of the following claims. Terms such as “preferred” or “in particular” or “especially” or “advantageous” or the like therefore denote only optional and exemplary embodiments.

1. A method for expanding at least a section of an initial tube blank (2) made of plastic or metal in such a way that an expanded tube blank (1) is obtained, which tapers in the direction of an end of the tube blank not affected by the expansion process, comprising the steps:
a) fixing the initial tube blank (2) in a holding device (4) in a first position (6a),
b) inserting a first mandrel (3) preheated to a first target temperature into the initial tube blank, wherein a longitudinal axis of the first mandrel coincides with a longitudinal axis (x) of the initial tube blank, wherein a maximum diameter (D1) of the first mandrel is greater than a maximum diameter (D2) of the initial tube blank, and a cross-sectional shape of the first mandrel corresponds to a cross-sectional shape of the initial tube blank,
c) pressing the first mandrel into the interior of the initial tube blank to a predetermined depth (T) and holding the first mandrel in the pressed-in position for a predetermined heating time period so that at least a section of the initial tube blank is expanded,
d) pulling the first mandrel out of the expanded tube blank (1), wherein, when pulling the first mandrel out of the expanded tube blank either:
compressed air is blown into the interior of the expanded tube blank through the first mandrel provided with at least one corresponding first air channel (5), or
the expanded tube blank is mechanically stripped.

2. The method of claim 1, further comprising the steps of:
e) moving the expanded tube blank (1) in the holding device (4) from the first position (6a) to a second position (6b) after the step d) of pulling the first mandrel out of the expanded tube blank,
f) inserting a second mandrel (7), which has been precooled to a second target temperature, into the expanded tube blank substantially to the intended depth (T), wherein the second mandrel is selected so that it corresponds to the first mandrel in terms of shape and volume and a longitudinal axis of the second mandrel coincides with a longitudinal axis (x) of the expanded tube blank,
g) cooling the expanded tube blank by holding the second mandrel in the inserted position for a predetermined cooling time period; and
h) pulling the second mandrel out of the expanded tube blank.

3. The method of claim 1, further comprising the steps of:
e) replacing the preheated first mandrel (3) with a second mandrel (7) precooled to a second target temperature after step d) of extracting the first mandrel from the expanded tube blank (1), wherein the second mandrel is selected to correspond to the first mandrel in terms of shape and volume,
f) inserting the second mandrel (7) into the expanded tube blank substantially to the intended depth (T), wherein a longitudinal axis of the second mandrel coincides with a longitudinal axis (x) of the expanded tube blank,
g) cooling the expanded tube blank by holding the second mandrel in the inserted position for a predetermined cooling time period; and
h) pulling the second mandrel out of the expanded tube blank.

4. The method of claim 2, wherein the heating time period and the cooling time period are selected to be the same, in particular by a corresponding setting of the first and/or the second target temperature.

5. The method of claim 2, wherein, when the second mandrel (7) is pulled out of the expanded tube blank (1), compressed air is blown into the interior of the expanded tube blank through the second mandrel provided with at least one second air channel (8).

6. The method of claim 2, wherein, after the second mandrel has been pulled out of the expanded tube blank, an actual temperature of the second mandrel is measured by means of a second temperature sensor and, depending on a temperature rise due to a cold input from the second mandrel into the expanded tube blank, the second mandrel is cooled again to the second target temperature before a next expanded tube blank is processed with the second mandrel.

7. The method of claim 2, wherein during the cooling period of an expanded tube blank, a next initial tube blank is expanded according to the steps of the method according to claim 1.

8. The method of claim 1, wherein after the first mandrel is pulled out of the expanded tube blank, an actual temperature of the first mandrel is measured by means of a first temperature sensor and, depending on a temperature drop due to a heat input from the first mandrel into the expanded tube blank, the first mandrel is heated up again to the first target temperature before a next initial tube blank is processed with the first mandrel.

9. The method of claim 1, wherein initial tube blanks with different cross-sectional shapes, in particular with circular or oval or star-shaped cross-sectional shape, can be expanded by providing for each type of cross-sectional shape of the initial tube blank a matching first mandrel, the cross-sectional shape of which corresponds to this type.

10. A device (9) for expanding at least a section of an initial tube blank (2) made of plastic or metal in such a way that an expanded tube blank (1) is obtained which tapers in the direction of an end of the tube blank which is not affected by the expansion operation, by means of the method of claim 1, comprising:
a holding device (4) for fixing the initial tube blank (2) in the first position (6a),
a first mandrel (3) having a maximum diameter (D1) larger than the maximum diameter (D2) of the initial tube blank (2), wherein a cross-sectional shape of the first mandrel corresponds to a cross-sectional shape of the initial tube blank,
a heater (10) for preheating the first mandrel to the first target temperature,
a first linear actuator (11) for shifting (R) the first mandrel (3) back and forth between an initial position, in which the first mandrel is located completely outside the initial tube blank (2) fixed in the first position (6a), and the pressed-in position.

11. The device of claim 10, further comprising a second mandrel (7) corresponding to the first mandrel in terms of shape and volume,
a cooling device (12) for cooling the second mandrel to a second target temperature,
a second linear actuator for shifting (R) the second mandrel back and forth between an initial position, in which the second mandrel is arranged completely outside the expanded tube blank (1), and a designated position inserted into the expanded tube blank for cooling the expanded tube blank.

12. The device of claim 11, wherein the cooling device comprises a second temperature sensor and a second controller, wherein the second controller is configured to set the second target temperature of the second mandrel based on an actual temperature of the second mandrel measured by the second temperature sensor, in particular after cooling each expanded tube blank or a number of initial tube blanks.

13. The device of claim 10, wherein the heater (10) comprises a first temperature sensor and a first controller, wherein the first controller is configured to set the first target temperature of the first mandrel based on an actual temperature of the first mandrel measured by the first temperature sensor, in particular after expanding each initial tube blank or a number of initial tube blanks.

14. The device of claim 10, wherein the first mandrel (3) comprises at least a first air channel (5) for introducing compressed air into the interior of the expanded tube blank (1), wherein an inlet of the first air channel is located in a section of the first mandrel that does not enter the tube blank, and the first air channel opens in the section of a free end of the first mandrel.

15. The device of claim 10, wherein the second mandrel (7) comprises at least one second air channel (8) for introducing compressed air into the interior of the expanded tube blank, wherein an inlet of the second air channel is located in a section of the second mandrel that does not enter the expanded tube blank, and the second air channel opens in the section of a free end of the second mandrel.

16. The device of claim 10, wherein the holding device is provided with a drive so that the expanded tube blank can be transported from the first position (6a) into a second position (6b) for cooling, in particular wherein the holding device (4) is formed either
as a circulating conveying device intermittently operated by means of the drive (13) with several receptacles for initial tube blanks or
as a rotating turret device intermittently operated by means of the drive (13) or
as a loading table.

17. The device of claim 10, comprising a plurality of first mandrels with different cross-sectional shapes, in particular with circular or oval or star-shaped cross-sectional shape, which are each assigned to initial tube blanks with correspondingly identical cross-sectional shapes, wherein, when a first initial tube blank is exchanged with a second initial tube blank with a different cross-section, the first mandrel used for the first tube blank is correspondingly exchanged with a second mandrel for the second tube blank in the device.
